(19) United States
(12) Patent Application Publication
(10) Pub. No.: US 2005/0093792 A1
(43) Pub. Date: May 5, 2005

(54) Light emitting element drive unit, display module having light emitting element drive unit and electronic apparatus equipped with such display module

(75) Inventors: Isao Yamamoto, Ukyo-ku (JP); Tomoyuki Ito, Ukyo-ku (JP)

Correspondence Address: HOGAN & HARTSON L.L.P., 500 S. GRAND AVENUE, SUITE 1900, LOS ANGELES, CA, 90071-2611, US

(73) Assignee: ROHM CO., LTD.

(21) Appl. No.: 10/976,576

(22) Filed: Oct. 29, 2004

(30) Foreign Application Priority Data
Oct. 30, 2003 (JP) 2003-370364

(51) Int. Cl. G09G 3/32

(52) U.S. Cl. 345/83

(57) ABSTRACT

A drive unit for driving multiple groups of light emitting elements operable at different voltages, though the drive unit is adapted to operate the different groups by means of a step-up circuit providing a low voltage. The inventive step-up circuit steps up a power source voltage (Vcc) to a predetermined positive voltage (Vp), which is inverted to a negative voltage (Vn) by an inverted voltage generating circuit. A first light emitting element group (first LED group) operable at a low voltage is by the positive voltage (Vp), with low necessary voltage emit light on positive voltage and grand voltage, while a second light emitting element group (second LED group) operable at a higher voltage is driven by a combination of the positive voltage (Vp) and the negative voltage (Vn). Thus, energy loss in the drive unit is reduced, thereby improving the operating efficiency of the drive unit.

### FIELD OF THE INVENTION

This invention relates to a drive unit for driving light emitting elements such as light emitting diodes (LEDs) operable at high voltages (the drive unit hereinafter referred to as light emitting element drive unit). The invention also relates to a display module using a light emitting element drive unit and to an electronic apparatus such as a cellular phone, a PDA, and a digital camera, equipped with such display module.

### BACKGROUND OF THE INVENTION

A light emitting element e.g. an LED, is used itself as a display element, and as a source of light for backlighting a liquid crystal display (LCD) as well.

The number of light emitting elements used in a display depends on the form of the display and the amount of light required.

FIGS. 8A and 8B show an appearance of a foldable cellular phone (or flip phone), which is a typical example of electronic apparatus that utilizes LEDs as light emitting elements. Particularly, FIG. 8A shows a condition of the cellular phone unfolded (opened), and FIG. 8B shows the condition when it is folded (closed).

Referring to FIGS. 8A and 8B, the cellular phone is shown to have an antenna 1, a large primary display 2 having a large display area, and an controller 3, and a secondary display 4. The secondary display 4 is provided to indicate reception of a telephone call and/or e-mail along with the date and time of the reception. The secondary display 4 requires a small display area. Each of the displays 2 and 4 comprises an LCD backlit by white, red, blue, or green LEDs. The numbers of backlight LEDs used with the LCD 2 and 4 are determined by the display areas of the LCDs.

FIG. 9 is a circuit diagram of a conventional display module for driving LEDs of a cellular phone as shown in FIGS. 8A and 8B. The module consists of a drive device 50 and a display device 60.

The display device 60 is provided with a first unit of light emitting elements, including two LEDs 61-62 connected in series with each other for use with the secondary display 4, and a second unit of four light emitting elements, including LEDs 63-66 connected together in series for use with the primary display 2 that requires a larger amount of light than the secondary display 4.

The drive device 50 comprises a switching step-up circuit 51 for stepping up a power source voltage Vcc of 3.6V supplied from a lithium battery for example to a high voltage Vhh. In the example shown herein, this high voltage Vhh is 18 V, since each of the display uses white or blue LEDs each requiring about 4 V for lighting. This high voltage Vhh is impressed on the LEDs 61-66. Drivers 52 and 53 are usually constant current drivers. Each of the drivers 52 and 53 provides a constant current when turned on, irrespective of the number of LEDs connected in series, and shuts down the current when turned off in response to a display instruction signal to control the amount of light emitted from the respective LEDs 61-66.

Japanese Patent Application Laid Open No. 2003-274646 discloses a system for turning on and off the first and second LED units individually, or simultaneously when they are connected in series.

However, in a prior art LED drive unit as shown in FIG. 9 having a larger number of LEDs in a second LED unit than in a first unit, a high voltage Vhh (which is 18 V in the example shown herein) is necessary for activation of the second unit. Therefore, the power supply circuit 51 must have a large step-up ratio.

When the first and second units of light emitting elements are driven simultaneously, the high voltage Vhh is also impressed on the first unit of a fewer elements, which results in a large energy loss by the constant current driver 52. That is, in the example shown in FIG. 9, if the voltage and current required for one light emitting element is Vf and If, respectively, the energy loss of If×(Vhh−2×Vf) will occur in the constant current driver 52 associated with the first unit. As a consequence, the energy loss lowers the power efficiency of the electronic apparatus such as a cellular phone.

In cases where the first and second units of light emitting elements are driven individually or simultaneously as taught in the literature cited above, the energy loss by the first unit can be suppressed. However, in order to drive a multiplicity of units of light emitting elements connected in series, a still higher voltage (for example, 4 V×6 elements+α=26 V) than conventional high voltage Vhh is required. To meet this requirement, therefore, the power supply unit must have a higher step-up ratio. In addition, a drive device and display device having a higher withstand voltage are needed.

### SUMMARY OF THE INVENTION

It is therefore an object of the invention to provide a light emitting element drive unit that is capable of driving a multiplicity of light emitting element groups operable at different voltages, using a step-up circuit providing a low drive voltage, thereby reducing the energy loss involved and improving its operating efficiency.

It is another object of the invention to provide a display module having such light emitting element drive unit.

It is a still another object of the invention to provide an electronic apparatus equipped with such display module.

A light emitting element drive unit in accordance with a first embodiment of the invention comprises:
a step-up circuit for stepping up a power source voltage to provide at the first-polarity voltage output terminal of said step-up circuit a predetermined voltage of a first polarity (referred to as first-polarity voltage);
an inverted-voltage generating circuit for inverting said first-polarity voltage into a voltage of a second polarity (referred to as second-polarity voltage) to be output from the second-polarity voltage output terminal of an inverted-voltage generating circuit;
a first driver connected between first-polarity voltage output terminal and a node having a reference voltage (the node referred to as reference voltage node), the first driver connectable in series with a first light emitting element group that causes a first voltage drop when activated and adapted to turn on and off in accord with a first instruction signal; and
a second driver provided between the first- and second-polarity voltage output terminals, the second driver connectable in series with a second light emitting element group that causes a second voltage drop larger than the first voltage drop when activated and adapted to turn on and off in accord with a second instruction signal.

Each of said first and second drivers may be a constant current driver adapted to supply a predetermined constant current when it is turned on.

The step-up circuit may be a switching step-up circuit, while the inverted-voltage generating circuit is a charge pump inverted-voltage generating circuit.

Both of the step-up circuit and the inverted-voltage generating circuit may be of charge pump type.

The light emitting elements of the first and second groups can be light emitting diodes emitting light of the same color.

The light emitting elements of said first group are red LEDs, while the light emitting elements of said second group are green and/or blue LEDs.

The display module of the invention may include:
a first light emitting element group;
a second light emitting element group that causes a larger voltage drop than said first group;
a step-up circuit for stepping up a power source voltage to provide at the first-polarity output terminal thereof a predetermined first-polarity voltage;
an inverted-voltage generating circuit for inverting the first-polarity voltage into a second-polarity voltage provided at the second-polarity voltage output terminal of the inverted-voltage generating circuit;
a first driver connected in series with the first light emitting element group and between the first-polarity voltage output terminal and a reference voltage node, the first driver adapted to turn on and off in accord with a first instruction signal; and
a second driver connected in series with the second light emitting element group and between the first- and second-polarity voltage output terminals, the second driver adapted to turn on and off in accord with a second instruction signal.

In the display module, the first and second drivers may be constant current drivers adapted to supply a predetermined constant current through them when they are turned on.

In the display module, said inverted-voltage generating circuit may be a charge pump type inverted-voltage generating circuit.

An electronic apparatus of the invention is equipped with a display module having a light emitting element drive unit and a multiplicity of light emitting element groups.

The electronic apparatus has a step-up circuit that generates a first-polarity (e.g. positive) voltage by stepping up a power source voltage, and an inverted-voltage generating circuit that generates a second-polarity (e.g. negative) voltage by inverting the first-polarity voltage. A first light emitting element group (e.g. first LED group), presumably having a low predetermined operating voltage, is driven to emit light by the positive voltage, while the second light emitting element group (e.g. second LED group) presumably having a high predetermined operating voltage is driven to emit light using the positive and negative voltage.

In this way, a multiplicity of light emitting element groups having different operating voltages can be driven by a step-up circuit that provides a low drive voltage. Thus, the step-up circuit can have a low step-up ratio (defined to be the ratio of step-up voltage/power source voltage). Moreover, the inventive light emitting element drive unit and a display module equipped with such drive unit can have a low withstand voltage.

Since the first light emitting element group (first LED group) is driven by a low voltage and the second light emitting element group (second LED group) by a high voltage, energy loss by the drive unit is minimized and have an improved drive efficiency.

### BRIEF DESCRIPTION OF THE DRAWINGS

FIG. 1 is a circuit diagram of an electronic apparatus equipped with a display having a multiplicity of light emitting element groups according to a first embodiment of the invention.

FIG. 2A is a circuit diagram of an inverted-voltage generating circuit for use with the invention.

FIG. 2B is a diagram describing the operation of the inverted-voltage generating circuit of FIG. 2A.

FIG. 3 is a circuit diagram of a constant current driver for use with the invention.

FIG. 4 is a circuit diagram of an electronic apparatus equipped with a display having a multiplicity of light emitting element groups according to a second embodiment of the invention.

FIG. 5 is a circuit diagram of another constant current driver for use with the invention.

FIG. 6 is a circuit diagram of an electronic apparatus equipped with a display having multiple groups of light emitting elements according to a third embodiment of the invention.

FIG. 7A shows a circuit of a step-up circuit utilizing a charge pump circuit for use with the invention.

FIG. 7B is a diagram describing operation of the charge pump circuit of FIG. 7A.

FIG. 8A shows an appearance of a foldable cellular phone to which the invention is applied, with its upper section flipped up.

FIG. 8B shows an appearance of the foldable cellular phone shown in FIG. 8A, with its upper section flipped down.

FIG. 9 is a circuit diagram of a conventional display module for driving LEDs of a cellular phone.

### DETAILED DESCRIPTION OF THE PREFERRED EMBODIMENTS

The invention will now be described in detail with reference to an electronic apparatus utilizing LEDs as light emitting elements, as shown in the accompanying drawings.

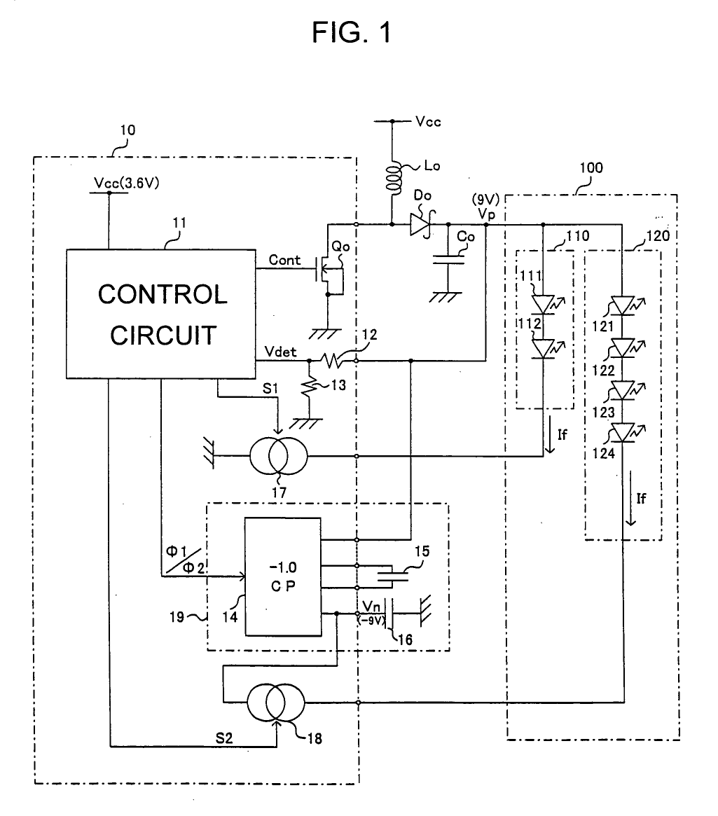

Referring to FIG. 1, there is shown an electronic apparatus equipped with a display having a multiplicity of light emitting element groups that are operable at different voltages and driven by a light emitting element drive unit according to a first embodiment of the invention. It is noted that the invention can be implemented as a display module equipped with such light emitting element drive unit and such display.

As shown in FIG. 1, this electronic apparatus has a display 100 and a light emitting element drive unit that comprises a control IC 10 and externally connected IC devices.

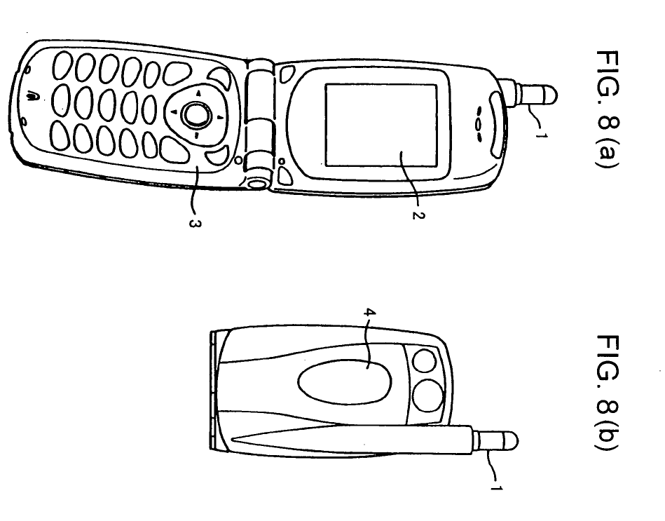

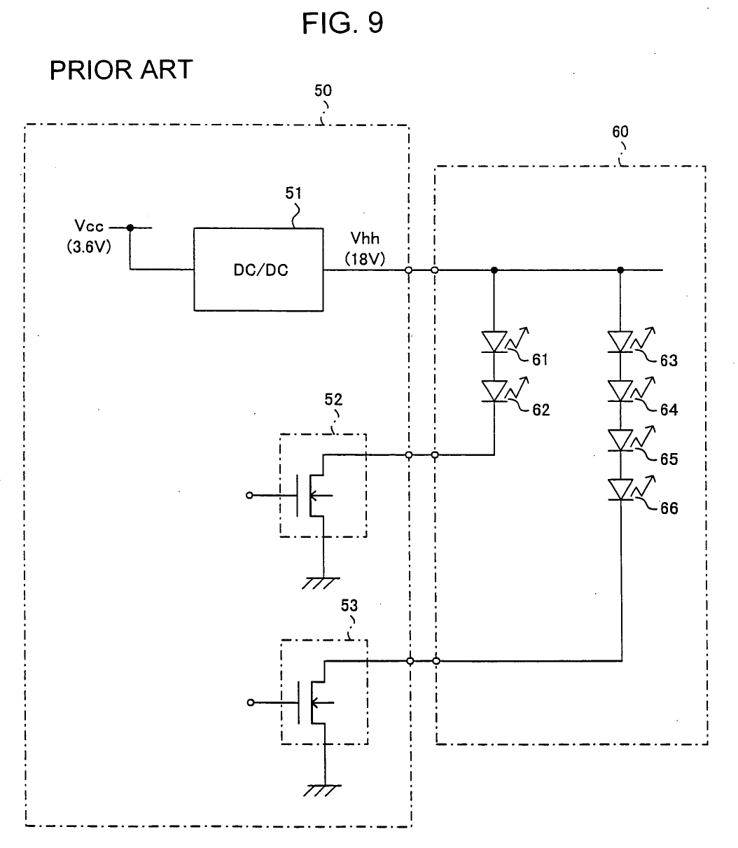

The display 100 is provided with a first light emitting element group 110 that includes two LEDs 111 and 112 connected in series with each other (the group referred to as first LED group), and a second light emitting element group 120 that includes four LEDs 121-124 connected in series in the order mentioned (the group referred to as second LED group). The LEDs 111 and 112 of the first LED group 110 is used as, for example, backlights of an LCD 4 shown in FIG. 8B, and the LEDs 121-124 of the second LED group is used as backlights of an LCD 2 shown in FIG. 8A. The first and second LED groups 110 and 120, respectively, are activated (or turned on) individually in some cases and simultaneously in some other cases.

These LEDs 111-124 are supplied with predetermined currents to provide predetermined luminescence. In this case, the voltage (drop) Vf generated across the respective LEDs 111-124 can vary from one LED to another. For a white LED or a blue LED, it varies in most cases in the range of, for example, 3.4 V to 4.0 V.

The first LED group 110, which includes two such LEDs in series, requires application of a voltage as high as about 8 V, which is the upper bound of the required voltage range for two LEDs. The second LED group 120 having four LEDs in series requires a still higher voltage of about 16 V, which is the upper bound of the required voltage range for four LEDs.

The light emitting element drive unit generates a voltage to be applied to the first and second groups 110 and 120, respectively, and controls on-off operation of the respective light emitting element groups.

A predetermined first-polarity voltage (hereinafter referred to as positive voltage) Vp (of 9V) to be supplied to the first LED group is obtained by stepping up a power source voltage Vcc (of 3.6V). It should be understood that the ground potential would be taken as the reference of voltages unless otherwise stated. This positive voltage Vp causes a coil Lo and an N-type MOS transistor Qo serving as a control switch to be connected between the power source voltage Vcc and the ground. Connected to the node of this coil Lo and the switch Qo via a diode Do is a rectifying and smoothing capacitor Co to charge the capacitor Co to the positive voltage Vp. The rectifying diode Do is preferably a Schottky diode that exhibits a small potential drop.

In order to maintain this positive voltage Vp at a constant level, it is divided by resistors 12 and 13 to generate a lower positive voltage (referred to as detection voltage) Vdet, which is fed back to a control circuit 11. The control circuit 11 has an error amplifier for comparing the detection voltage Vdet with a reference voltage to generate a comparison signal (referred to as error signal). The error signal is further compared with a triangular wave signal in a PWM comparator. The PWM comparator provides a PWM pulse signal having a duty ratio in accord with the difference between the detection voltage Vdet and the reference voltage. The PWM pulse signal is input to the gate of the switch Qo as a switch control signal Cont to control on-off operation of the switch Qo. Thus, the predetermined positive voltage Vp is generated by a switching step-up circuit that comprises the coil Lo, switch Qo, rectifying diode Do, smoothing capacitor Co, resistors 12 and 13, and control circuit 11.

The positive voltage Vp is input into an inverted-voltage generating circuit 19, which generates an inverted second-polarity voltage (hereinafter referred to as negative voltage) Vn.

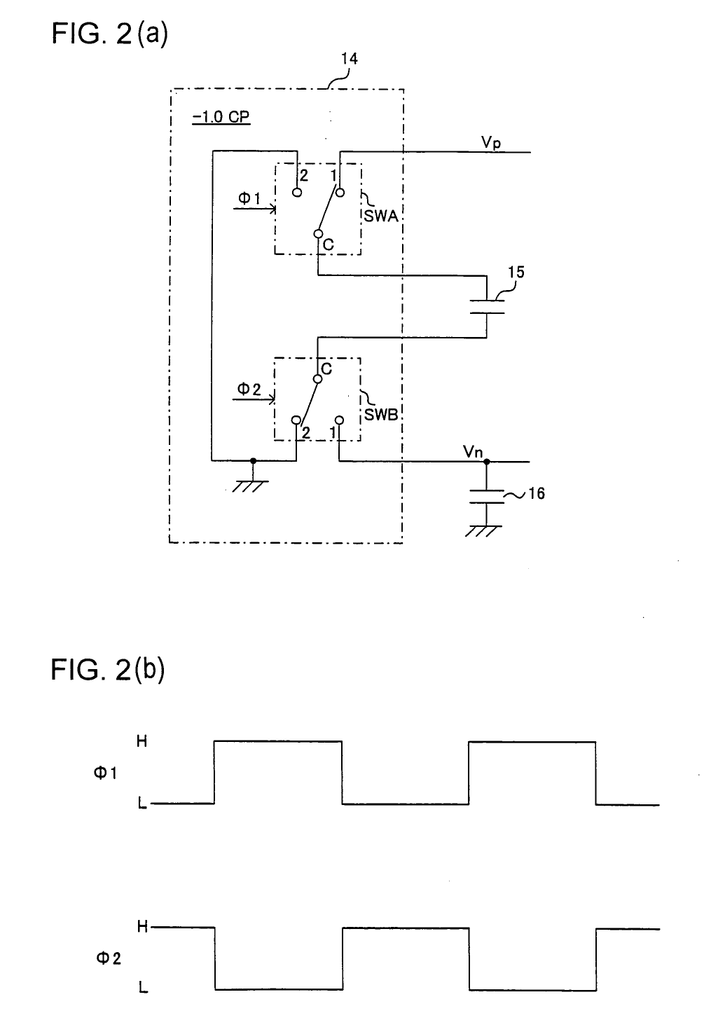

The inverted-voltage generating circuit 19 consists of a charge pump type inverted-voltage generation circuit (−1.0CP) 14 adapted to generate a voltage by inverting the polarity of the positive voltage Vp as shown in FIG. 2A, a flying capacitor 15, and a capacitor 16 for generating a negative voltage. The polarity inverting charge pump circuit 14 has a first changeover switch SWA driven by a first clock φ1, and a second changeover switch SWB driven by a second clock φ2 which is complementary to the first clock φ1. The first switch terminal 1 of the first changeover switch SWA is coupled to the positive voltage Vp, and the first switch terminal 1 of the second changeover switch SWB is coupled to the negative voltage Vn. Common terminals Cs of the first changeover switch SWA and the second changeover switch SWB are respectively connected to the opposite ends of the flying capacitor 15. The second switch terminals 2 of both of the first and second changeover switches SWA and SWB, respectively, are grounded.

This arrangement permits switching of the first and second changeover switches SWA and SWB, respectively, as shown in FIG. 2B, such that, when the first clock φ1 is pulled up to a high level (H), and the second clock φ 2 is pulled down to a low level (L). Under this condition, the flying capacitor 15 is charged to the positive voltage Vp. Conversely, when the first clock φ1 is pulled low (L) and the second clock φ2 is pulled high (H), each of the first and second changeover switches SWA and SWB, respectively, is switched to the opposite state relative to the state described above. Under this condition, the capacitor 16 is charged by the flying capacitor 15 towards the negative voltage Vn. Repeating this switching operation, the capacitor 16 is charged to the inverted positive voltage Vp, i.e. the negative voltage Vn (of −9 V).

Referring again to FIG. 1, the first LED group 110 and a first driver 17 are shown to be connected in series between the output terminal providing the positive voltage Vp and the ground. When a first instruction signal Si is supplied from the control circuit 11, the first driver 17 is turned on, causing current to flow through the first LED group 110. The first driver 17 is turned off when the first instruction signal S1 is stopped.

The second LED group 120 and a second driver 18 are connected in series between the output terminal providing the positive voltage Vp and the output terminal providing the negative voltage Vn. When a second instruction signal S2 is supplied from the control circuit 11, the second driver 18 is turned on, causing current to flow through the second LED group 120. The second driver 18 is turned off when the second instruction signal S2 is stopped. Since the potential difference between the output terminal providing the positive voltage Vp and the output terminal providing the negative voltage Vn is twice (≈18 V) the positive voltage Vp, the voltage is sufficient to drive the four serially connected LEDs 121-124 of the second LED group 120.

It is preferred to have the first and second drivers 17 and 18, respectively, turned on to supply constant currents when they are fed the first and second instruction signals S1 and S2, respectively. It is preferable that the magnitudes of the constant currents can be arbitrarily regulated.

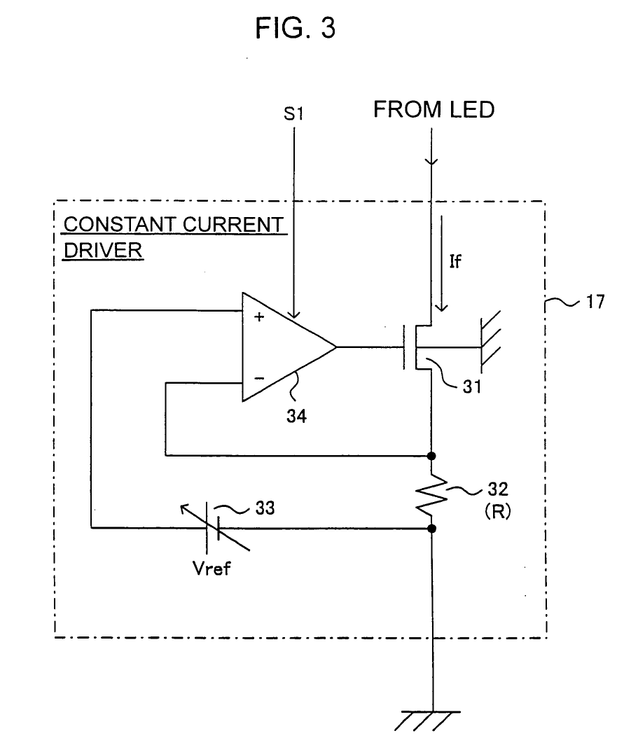

FIG. 3 shows an exemplary structure of the first driver 17, in which an N-type MOS transistor (referred to as NMOS) 31 and a detection resistor 32 are connected in series between the first LED group 110 and the ground. The difference between the potential drop R•If created across the detection resistor 32 and the reference voltage Vref of the reference voltage source 33 is amplified by an error amplifier 34 to control the gate voltage of the NMOS 31. The constant current driver 17 can be turned on or off by controlling the operating voltage of the error amplifier 34 by the instruction signal Si. The magnitude of the constant current If can be set to an arbitrary level by adjusting the reference voltage Vref.

To utilize the constant current driver of FIG. 3 as a constant current driver 18 for the second LED group 120, it may be connected between the second LED group 120 and the output terminal providing the negative voltage Vn.

As will be understood from the description above, the control circuit 11 controls such operation of the inventive electronic apparatus as step-up operation of the step-up circuit, provision of the first and second clocks φ1 and φ2, respectively, to the inverted-voltage generating circuit, and provision of the first and second instruction signals S1 and S2.

It should be understood that although the numbers of the LEDs of the first and second groups have been described to be 2 and 4 in the foregoing example, the numbers are not limited to 2 and 4. In fact arbitrary numbers of LEDs can be used (e.g. 1 and 2, or of 3 and 6). Moreover, although the ratio of the numbers of the LEDs of the first to the second group has been 1 to 2 in the above example, the ratio is arbitrary, being, for example, 2 to 5 or 3 to 5. This is the case in other embodiments that will be described below.

In operation, as the electronic apparatus is turned on, the step-up circuit starts generating the positive voltage Vp (+9V), which is supplied to the inverted-voltage generating circuit 19, which in turn generates the negative voltage Vn (−9V). The positive voltage Vp and the negative voltage Vn are generated independently of the first and second instruction signals S1 and S2.

When the first and second instruction signals S1-S2 are not supplied to the first and second drivers 17-18, both the first and second LED groups 110 and 120, respectively, are turned off.

If the first instruction signal Si is supplied, the first driver 17 turns on, allowing predetermined constant current If to flow through the first LED group 110, as determined by the reference voltage Vref. Each of the LEDs 111-112 of the first LED group 110 emits light of the intensity in accord with the constant current If.

If the second instruction signal S2 is supplied, the second driver 18 will turn on, which causes predetermined constant current If to flow through the second LED group 120, as determined by the reference voltage Vref. Each of the LEDs 121-124 of the second LED group 120 emits light of the intensity in accord with the constant current If.

If both the first and second instruction signals S1 and S2, respectively, are supplied, both the first LED group 110 and the second LED group 120 turn on.

Thus, the step-up circuit and the inverted-voltage generating circuit 19 suffice to always sustain the same operation, irrespective of whether the first and second instruction signals S1 and S2 are supplied, or which of the signals is supplied to the LEDs. This implies that, in the design of the step-up circuit, the step-up ratio can be fixed at an optimum ratio at which respective components can operate most efficiently.

It should be appreciated that different LED groups 110 and 120 requiring different operating voltages can be driven using a common low voltage (which is 9 V in the example shown herein). In this way, the step-up ratio of the step-up circuit (defined by Vp/Vcc, where Vp is the step-up voltage and Vcc is the power source voltage) can be reduced less than conventional step-up ratios. As a consequence, withstand voltage of the light emitting element drive unit and the display module utilizing such drive can be lowered accordingly.

It should be noted that, while the first LED group 110 is driven by a low voltage Vp, the second LED group 120 is driven by a high voltage of (Vp+|Vn |). Thus, voltage drops in the first and second drivers 17 and 18 are small, thereby resulting in less electric power loss and improving the operating efficiency of the light emitting element drive unit.

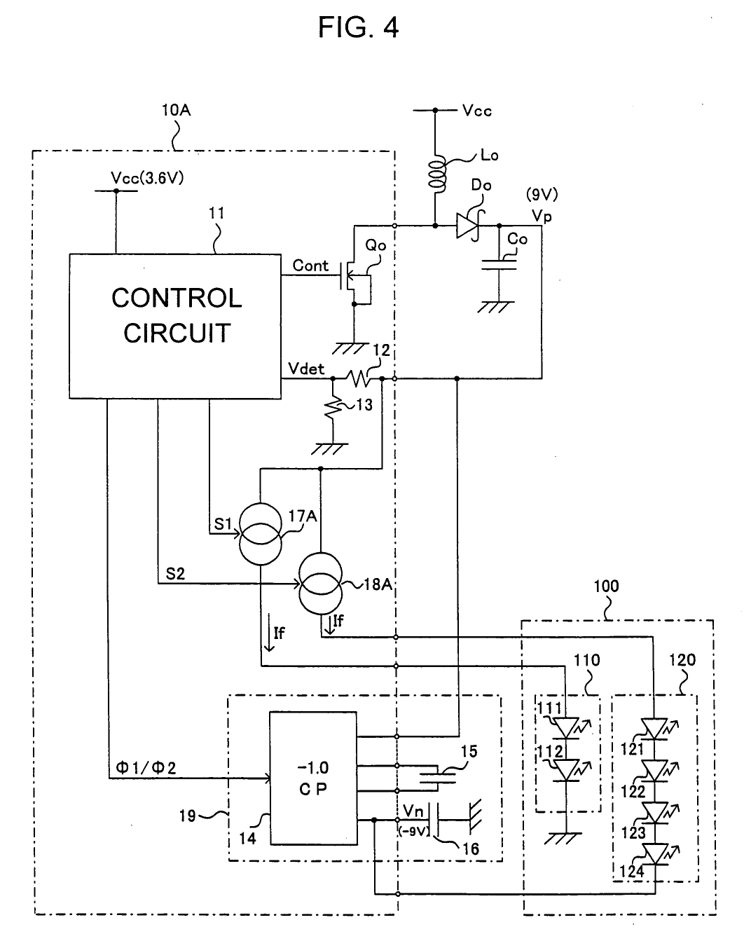

FIG. 4 is a circuit diagram of an electronic apparatus equipped with a display having a multiplicity of light emitting element groups in accordance with a second embodiment of the invention.

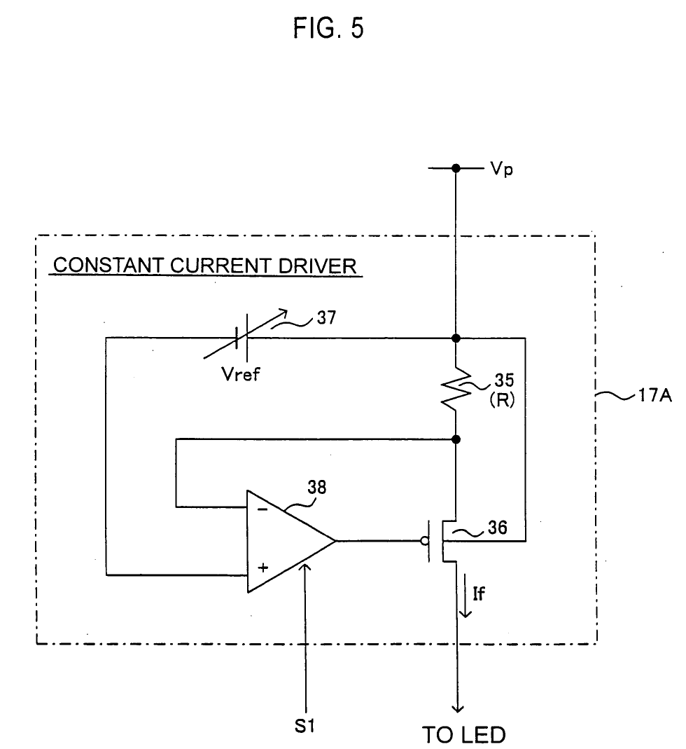

In the second embodiment shown in FIG. 4, a first driver 17A is connected to the output terminal providing the positive voltage Vp and to one end of the first LED group 110. The other end of the first group 110 is grounded. A second driver 18A is connected to the output terminal providing the positive voltage Vp and to one end of the second LED group 120. The other end of the second group 120 is connected to the output terminal providing the negative voltage Vn. As connected in this way, the first and second drivers 17A and 18A, respectively, have a structure as shown in FIG. 5.

The constant current driver 17A of FIG. 5 is provided between the output terminal providing the positive voltage Vp and the first LED group 110. The constant current driver 17A has a detection resistor 35 and a P-type MOS transistor (referred to as PMOS) 36 connected in series with the resistor 35, and is connected between the output terminal providing the positive voltage Vp and the first LED group 110. To control the gate voltage of the PMOS 36, the difference between the voltage drop R-If across the detection resistor 35 and the reference voltage Vref supplied from a reference voltage source 37 is amplified by an error amplifier 38 before it is supplied to the gate of the PMOS 36. The constant current driver 17A can be turned on or off by controlling the power to the error amplifier 36 by the instruction signal S1. The magnitude of the constant current If that flows through the constant current driver 17A can be set to an arbitrary level by adjusting the reference voltage Vref.

To use the constant current driver 18A shown in FIG. 5 as the constant current driver for the second LED group 120, it is connected in series with the output terminal providing the positive voltage Vp and with one end of the second LED group 120.

Elements of the second embodiment of FIG. 4 similar to those of FIG. 1 are indicated by similar reference numerals. The second embodiment can provide the same functions as the first embodiment. The first and second drivers 17A and 18A, respectively, providing different currents to different groups of light emitting elements, can be of the same structure. Therefore, the drive unit can be simplified in structure.

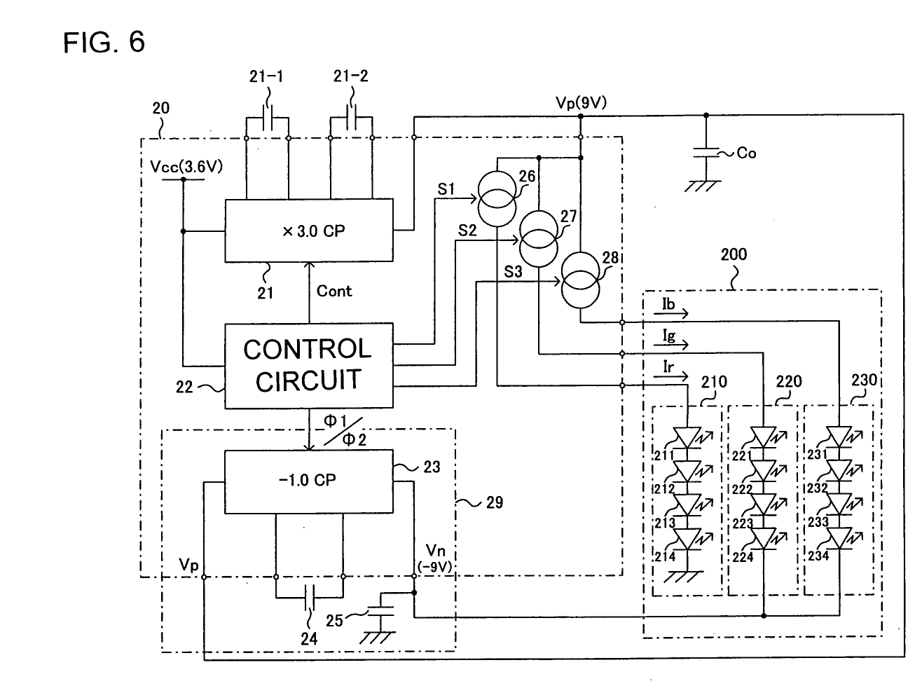

FIG. 6 is a circuit diagram of an electronic apparatus equipped with a display having a multiplicity of light emitting element (LED) groups in accordance with a third embodiment of the invention. In the example shown, the display has a first LED group for emitting red light (R) (referred to as red LEDs), a second LED group for emitting green light (G) (referred to as green LEDs), and a third LED group for emitting blue light (B) (referred to as blue LEDs), three groups being operable at different voltages. Incidentally, the invention may be configured as a display module equipped with the light emitting element drive unit and a display.

As seen from FIG. 6, this electronic apparatus is equipped with a display 200 and a light emitting element drive unit having a control IC 20 and externally connected ICs.

The display 200 is provided with a first group 210 of four serially connected red LEDs 211-214, a second group 220 of four serially connected green LEDs 221-224, and a third group 230 of four serially connected blue LEDs 231-234. In the example shown herein, the first through third groups 210-230 of LEDs 211-214, 221-224, and 231-234 are used as backlight sources of an LCD. The first through third LED groups 210-230 are mostly turned on simultaneously, such that light of a predetermined color is emitted by adjusting the currents. Of course, the LED groups may be turned on independently as needed.

In order to emit predetermined amounts of light from the three groups of LEDs 211-214, 221-224, and 231-234, currents Ir, Ig, and Ib of predetermined magnitudes are passed through the respective groups. As is the case with white LEDs, nominal drive voltage to be impressed on each LED of the same color differs slightly from one LED to another. Moreover, drive voltages of LEDs of different colors differ greatly. Thus, for example, the drive voltage to be impressed on each element is about 2.0 V for red LED, about 3.5 V for green LED and blue LED.

Thus, a voltage as high as 8 V must be impressed on the first LED group 210 of four serially connected LEDs 211-214, and a higher voltage of about 14 V on both the second LED group 220 of four serially connected green LEDs 221-224 and the third LED group 230 of four serially connected blue LEDs 231-234.

The light emitting element drive unit not only generates three voltages to be applied to the first through third LED groups 210-230, but also controls on-off states of the first through third groups 210-230.

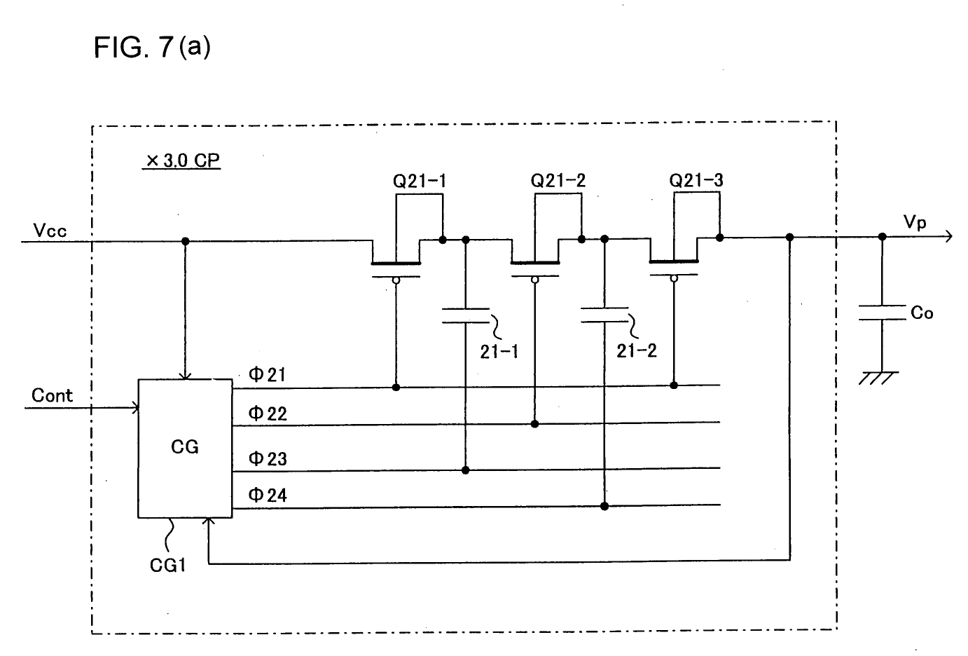

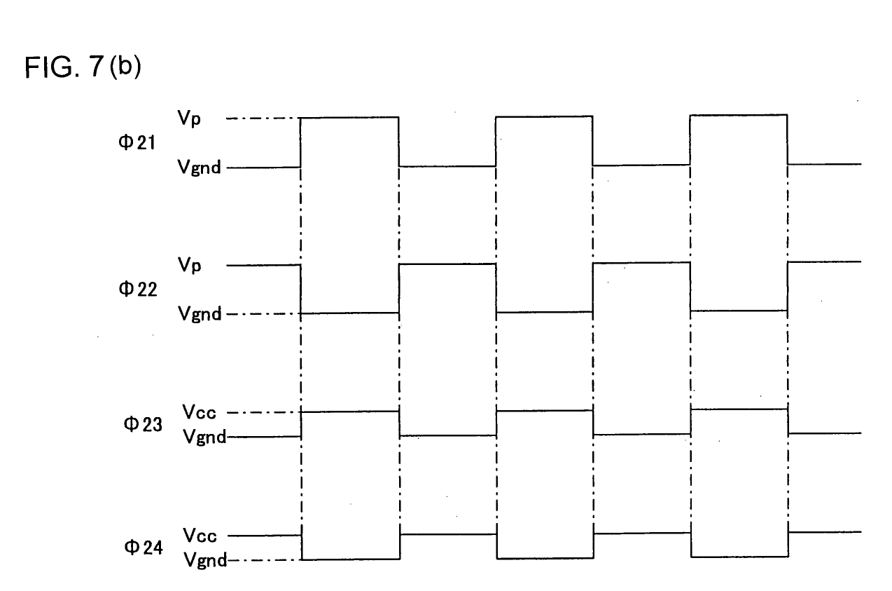

In order to obtain the predetermined positive voltage Vp (9 V) from a power source voltage Vcc (3.6 V), the embodiment has a step-up circuit that includes a charge pump step-up circuit 21, and externally connected charge pump capacitors 21-1 and 21-2 and a smoothing capacitor Co, as shown in FIG. 7A.

FIG. 7B shows a diagram illustrating operation of the step up circuit utilizing a charge pump step-up circuit 21. As shown in FIG. 7A, PMOS Q21-1-Q21-3 connected in series are supplied on the input side thereof with a power source voltage Vcc. Connected to the output ends of the PMOS Q21-1-Q21-3 are one ends of capacitors 21-1, 21-2, and Co, respectively. The two-phase clocks 0 23 and q 24 are supplied to the other ends of the capacitors 21-1 and 21-2. The capacitor Co is charged to the positive voltage Vp.

A clock generator CG1 is supplied with a control signal Cont from a control circuit 22 and a power source voltage Vcc, and outputs first through fourth clocks φ21-φ24, all synchronized as shown in FIG. 7B. The first and second clocks φ21 and φ22, respectively, are complementary two-phase clocks, which vary between the ground voltage Vgnd and the positive voltage Vp. The first clock φ21 is supplied to the gates of odd-numbered PMOS Q21-1 and Q21-3, while the second clock φ22 is supplied to the gate of an even-numbered PMOS Q21-2, thereby controlling on-off operation of these transistors accordingly.

Similarly, the third and fourth clocks φ23 and φ24, respectively, are complementary two-phase clocks, and vary between the ground voltage Vgnd and the power source voltage Vcc. The third clock φ23 is supplied to the other end of the capacitor 21-1, and the fourth clock φ24 is supplied to the other end of the capacitor 21-2. The amplitude (Vcc-Vgnd) of the third and fourth clocks φ23 and φ24, respectively, is the step-up voltage of the respective charge pump units.

This step-up circuit steps up voltage in two steps using two charge pump units. The circuit can output positive voltage Vp of up to 3×Vcc minus the voltage drops across the PMOS Q21-1-Q21-3.

In order to output an adequate positive voltage Vp, the step-up circuit is preferably configured to undergo constant voltage operation. To do this, one may take advantage of the positive voltage Vp that is input as a feedback voltage. That is, the positive voltage can be divided by resistors to form the detection voltage. On the other hand, a reference voltage is formed using, for example, a band-gap type constant voltage circuit. The detection voltage and the reference voltage are compared in a comparator. When the detection voltage exceeds the reference voltage, the clock generator CG 1 is stopped, stopping the clocks φ21-φ24. When the clocks φ21-φ24 are stopped, operation of the step-up circuit is stopped. As the detection voltage lowers below the reference voltage, the clock generator CG1 resumes generation of the clocks to resume the step-up operation. In order to ensure stable step-up operation, the comparator preferably has a hysteresis characteristic.

The positive voltage Vp is input into an inverted-voltage generating circuit 29, which inverts the polarity of the input signal to output the second-polarity voltage (negative voltage) Vn.

The inverted-voltage generating circuit 29 has a structure similar to that of inverted-voltage generating circuit 19 of FIG. 1. It includes a charge pump circuit 23 for polarity inversion, a flying capacitor 24, and a capacitor 25 for outputting the negative voltage. Thus, the capacitor 25 is charged to the negative voltage Vn (of −9 V) as a result of the inversion of the positive voltage. Vp.

A first driver 26 and the first light emitting element group 210 are connected in series between the output terminal providing the positive voltage Vp and the reference (ground) potential. The first driver 26 turns on upon receipt of a first instruction signal S1 from the control circuit 22, allowing current to flow through the first light emitting element group 210. The driver turns off when the first instruction signal S1 is stopped.

A second driver 27 and the second light emitting element group 220 are connected in series between the output terminal providing the positive voltage Vp and the output terminal providing the negative voltage Vn. The second driver 27 turns on upon receipt of a second instruction signal S2 from the control circuit 22, allowing current to flow through the second light emitting element group 220. The driver turns off when the second instruction signal S2 is stopped.

A third driver 28 and the third light emitting element group 230 are connected in series between the output terminal providing the positive voltage Vp, and the output terminal providing the negative voltage Vn. The third driver 28 turns on upon receipt of a third instruction signal S3 from the control circuit 22, allowing current to flow through the third light emitting element group 230. The driver turns off when the third instruction signal S3 is stopped.

Since the voltage between the output terminal providing the positive voltage Vp and the output terminal providing the negative voltage Vn is twice (about 18 V) the positive voltage Vp, it is sufficiently large to drive both the second group 220 of four serially connected LEDs 221-224 and the third group 230 of four serially connected LEDs 231-234.

Each of the first through the third drivers 26-28 is preferably a constant current driver that turns on to supply constant current when it is fed the associated one of the first through the third instruction signals S1-S3. It is preferable that the magnitude of the constant current can be arbitrarily regulated as needed. The constant current drivers shown in FIG. 5 can be used as the drivers 26-28.

As will be understood from the foregoing description, the control circuit 22 of the electronic apparatus has such functions as controlling the step-up circuit, providing the first and second clocks to the inverted-voltage generating circuit, and supplying first through third instruction signals S1-S3.

In operation, as the electronic apparatus is turned on, the step-up circuit starts generating the positive voltage Vp (+9V), which is supplied to the inverted-voltage generating circuit 29, which in turn generates the negative voltage Vn (−9V). The positive voltage Vp and the negative voltage Vn are generated independently irrespective of the first through third instruction signals S1-S3.

When none of the first through third instruction signals S1-S3 is supplied to the first-third drivers 26-28, respectively, none of the first through third LED groups 210-230 turns on.

When one or more of the instruction signals S1-S3 is(are) supplied, associated one(s) of the drivers 26-28 turn(s) on, causing predetermined constant currents Ir, Ig, and Ib to flow, as determined by the reference voltage Vref, through the associated one(s) of the LED groups 210-230, Each of the LEDs of the first through third LED groups 210-230 emits light of the intensity in accord with the constant current Ir, Ig, and lb.

It is noted that the step-up circuit and the inverted-voltage generating circuit 29 can sustain the same (i.e. constant) operation independently of whether the first through third instruction signals S1-S3 are supplied or not, or which of the signals is supplied. This implies that in the design of the step-up circuit the step-up ratio of the circuit can be fixed at an optimum ratio at which its components can operate most efficiently.

The electronic apparatus according to the third embodiment has the same features as the first and second embodiments. Particularly, as compared with similar conventional electronic apparatuses, the electronic apparatus has a light emitting element drive unit and a display module utilizing the drive unit of lower withstand voltage, thereby suffering less power loss and having an improved efficiency.

In any of the embodiments of the invention described above, a switching step-up circuit as shown in FIG. 1 and a charge pump type step-up circuit as shown in FIG. 6 can be utilized interchangeably.

Although the invention has been described above by way of example with particular reference to a foldable cellular phone, the invention is not limited to the examples as described and shown. A person skilled in the art will understand that the invention can be applied to any other display module, and hence to an electronic apparatus equipped with such display module, that has a multiplicity of light emitting element groups operable at different voltages and is driven by a drive unit providing a low voltage.

1. A light emitting element drive unit, comprising:
a step-up circuit for stepping up a power source voltage to provide at the first-polarity voltage output terminal of said step-up circuit a predetermined first-polarity voltage;
an inverted-voltage generating circuit for inverting said first-polarity voltage into a second-polarity voltage provided at the second-polarity voltage output terminal of said inverted-voltage generating circuit;
a first driver provided between said first-polarity voltage output terminal and a node (reference voltage node) having a reference voltage, said first driver connectable in series with a first light emitting element group that causes a first voltage drop when activated and adapted to turn on and off in accord with a first instruction signal; and
a second driver provided between said first- and second-polarity voltage output terminals, said second driver connectable in series with a second light emitting element group that causes a second voltage drop larger than said first voltage drop when activated and adapted to turn on and off in accord with a second instruction signal.

2. The light emitting element drive unit according to claim 1, wherein each of said first and second drivers is a constant current driver adapted to supply a predetermined constant current when it is turned on.

3. The light emitting element drive unit according to claim 2, wherein said step-up circuit is a switching step-up circuit, while said inverted-voltage generating circuit is a charge pump type inverted-voltage generating circuit.

4. The light emitting element drive unit according to claim 2, wherein said step-up circuit is a charge pump type step-up circuit, and said inverted-voltage generating circuit is a charge pump type inverted-voltage generating circuit.

5. The light emitting element drive unit according to claim 2, wherein said light emitting elements of the first and second groups are light emitting diodes that emit light of the same color.

6. The light emitting element drive unit according to claim 2, wherein the light emitting elements of said first group are red LEDs, while the light emitting elements of said second group are green and/or blue LEDs.

7. The light emitting element drive unit according to claim 1, wherein said step-up circuit is a switching step-up circuit, while said inverted-voltage generating circuit is a charge pump type inverted-voltage generating circuit.

8. The light emitting element drive unit according to claim 1, wherein said step-up circuit is a charge pump step-up circuit, and said inverted-voltage generating circuit is a charge pump inverted-voltage generating circuit.

9. The light emitting element drive unit according to claim 1, wherein said light emitting elements of the first and second groups are LEDs that emit light of the same color.

10. The light emitting element drive unit according to claim 1, wherein the light emitting elements of said first group are red LEDs, while the light emitting elements of said second group are green and/or blue LEDs.

11. A display module, comprising:
a first light emitting element group;
a second light emitting element group that causes a larger voltage drop than said first group;
a step-up circuit for stepping up a power source voltage to provide at the first-polarity output terminal of said step-up circuit a predetermined first-polarity voltage;
an inverted-voltage generating circuit for inverting said first-polarity voltage into a second-polarity voltage provided at the second-polarity voltage output terminal of said inverted-voltage generating circuit;
a first driver connected in series with said first light emitting element group and between said first-polarity voltage output terminal and a reference voltage node, said first driver adapted to turn on and off in accord with a first instruction signal; and
a second driver connected in series with said second light emitting element group and between said first-polarity voltage output terminal and second polarity voltage output terminal, said second driver adapted to turn on and off in accord with a second instruction signal.

12. The display module according to claim 11, wherein each of said first and second drivers is a constant current driver adapted to supply a predetermined constant current when it is turned on.

13. The display module according to claim 12, wherein said inverted-voltage generating circuit is a charge pump type inverted-voltage generating circuit.

14. The display module according to claim 12, wherein said light emitting elements of the first and second groups are light emitting diodes that emit light of the same color.

15. The display module according to claim 12, wherein the light emitting elements of said first group are red LEDs, while the light emitting elements of said second group are green and/or blue LEDs.

16. The display module according to claim 11, wherein said light emitting elements of the first and second groups are light emitting diodes that emit light of the same color.

17. The display module according to claim 11, wherein the light emitting elements of said first group are red LEDs, while the light emitting elements of said second group are green and/or blue LEDs.

18. An electronic apparatus comprising a display module according to any one of claims 11 through 17.
